(19) United States
(12) Patent Application Publication
(10) Pub. No.: US 2008/0276403 A1
(43) Pub. Date: Nov. 13, 2008

(54) Connection Between A Wiper Arm And A Wiper Blade In Addition To Windscreen Wiper Arrangement

(75) Inventors: Gerhard Schremmer, Bietigheim-Bissingen (DE); Klaus Walter, Asperg (DE)

Correspondence Address: OSHA LIANG L.L.P., 1221 MCKINNEY STREET, SUITE 2800, HOUSTON, TX, 77010, US

(73) Assignee: Valeo Wischersysteme GmbH, Bietigheim-Bissingen (DE)

(21) Appl. No.: 11/630,228

(22) PCT Filed: Jun. 22, 2005
(86) PCT No.: PCT/EP2005/006733

§ 371 Date: Jan. 8, 2008

(30) Foreign Application Priority Data
Jun. 24, 2004 (DE) 10 2004 030 429.7

(51) Int. Cl. B60S 1/40

(52) U.S. Cl. 15/250.32

(57) ABSTRACT

With a connection between a wiper arm of a windscreen wiper unit and a wiper blade arranged at one end of the wiper arm and arranged laterally from one side of the wiper arm, which is pushed with a bearing opening in a connecting piece on the wiper blade side axially onto a connecting stud on the wiper arm side projecting over the wiper arm side and is axially secured on the connecting stud by subsequent pivoting around the axis of the connecting stud by locking surfaces that clamp behind one another, one of the locking surfaces is formed on a locking element, which projects from a side of the connecting piece adjacent to the wiper arm and clamps behind a surface of the wiper arm adjacent to the connecting piece with the wiper blade secured axially to the wiper arm.

The invention refers to a connection between a wiper arm of a windscreen wiper unit for vehicles and a wiper blade arranged at the end of the wiper arm according to the generic term of patent claim 1. The invention furthermore refers to a windscreen wiper arrangement, with a least one wiper arm and a replaceable wiper blade according to the generic term of patent claim 14, arranged at a free end of the wiper arm.

Connections between a wiper blade and a wiper arm, in which the wiper blade, after tilting away the wiper arm from the vehicle windscreen and after pivoting the wiper blade relative to the wiper arm, can be removed from a laterally displaced connecting stud or pin arranged on the wiper arm or in which inversely for installation of the wiper blade, the latter can be laterally pushed on to the connecting stud of the wiper arm with a connection piece and subsequently can be axially secured by pivoting around the axis of the connecting stud, are well known n principle (WO 00/73113 A1 and DE 101 63 221 A1).

Common to all these well known connections, which are also designated as a side pin connection, is the fact that for axial locking of the wiper blade on the wiper arm, which constantly exists when the wiper blade is pivoted into a position around the connecting stud relative to the wiper arm, which corresponds to that which the wiper blade lying against the vehicle windscreen has in relation to the wiper arm, a securing or locking section is provided for axial locking or securing to the wiper arm, which subsequently clamps behind a surface of this wiper blade or the connecting piece on the wiper blade when the wiper blade is secured.

The disadvantage in this case is that the known solutions are expensive in terms of materials and furthermore the elements used for the axial locking constitute a visually disturbance.

The purpose of the invention is to eliminate these disadvantages and demonstrate a connection that can be realised with a high degree of reliability and reduced expenditure in terms of materials together with a visually appealing design. In order to fulfil this purpose, a connection according to patent claim 1 is illustrated. A windscreen wiper arrangement with such a connection is the subject of patent claim 14.

In a preferred realisation of the invention, axial securing of the wiper blade is performed by a locking element on a securing and reinforcing element, which is manufactured as a corrosion-resistant machined part or punched-bent part from metal sheeting and forms a constituent part of the connecting piece on the wiper blade side. This securing element not only forms the locking element, which clamps behind a surface adjacent to the connecting piece or wall of the wiper arm for axial securing but the securing and reinforcement element also overlaps the wiper blade and the carrier or holder for the wiper rubber and for further functional elements with its U profile and with the shanks there.

By means of a single-piece constructive element, i.e. by the securing element, axial securing is therefore guaranteed, but at the same time also securing of further functional elements of the wiper blade on the connecting stud, thereby resulting in a particularly reliable construction.

Further developments of the invention are subjects of the sub-claims. The invention will be explained in more detail below on the basis of the figures in a realisation example. They show:

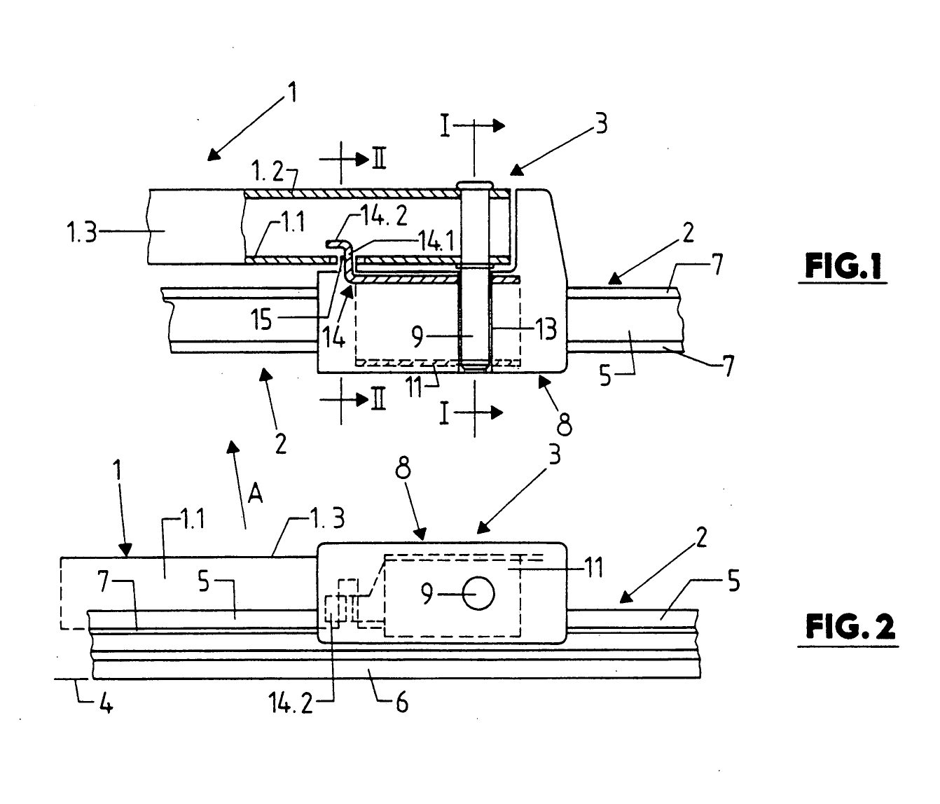

FIG. 1 in a very simplified partial presentation, a top view of a wiper arm and a wiper blade held on this wiper arm of a windscreen wiper unit for vehicles;

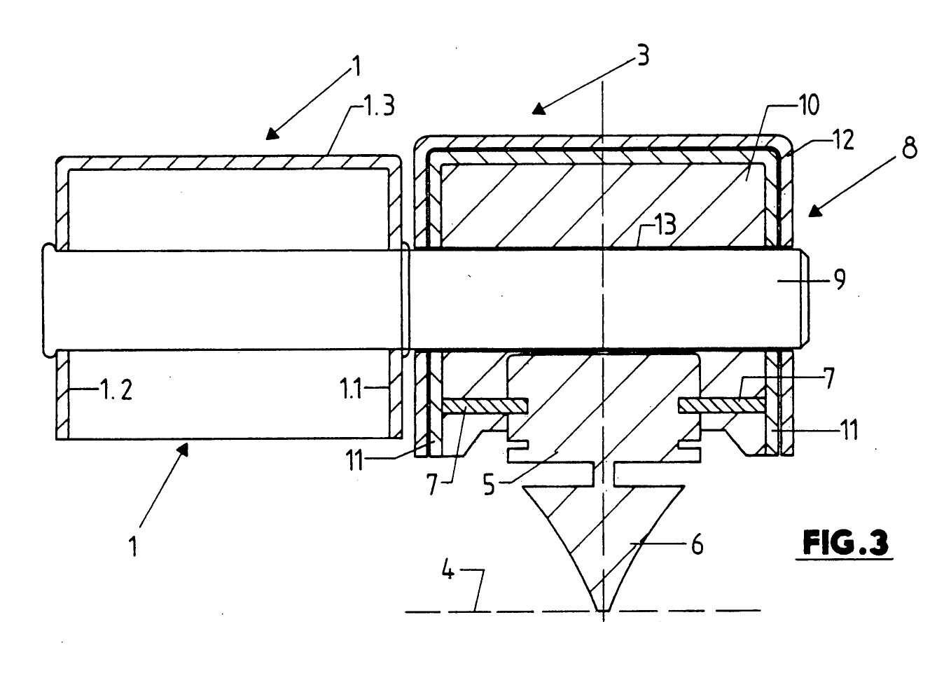

FIG. 2 in a partial presentation, the wiper arm in addition to the wiper blade in a side view at the connection and side pin connection;

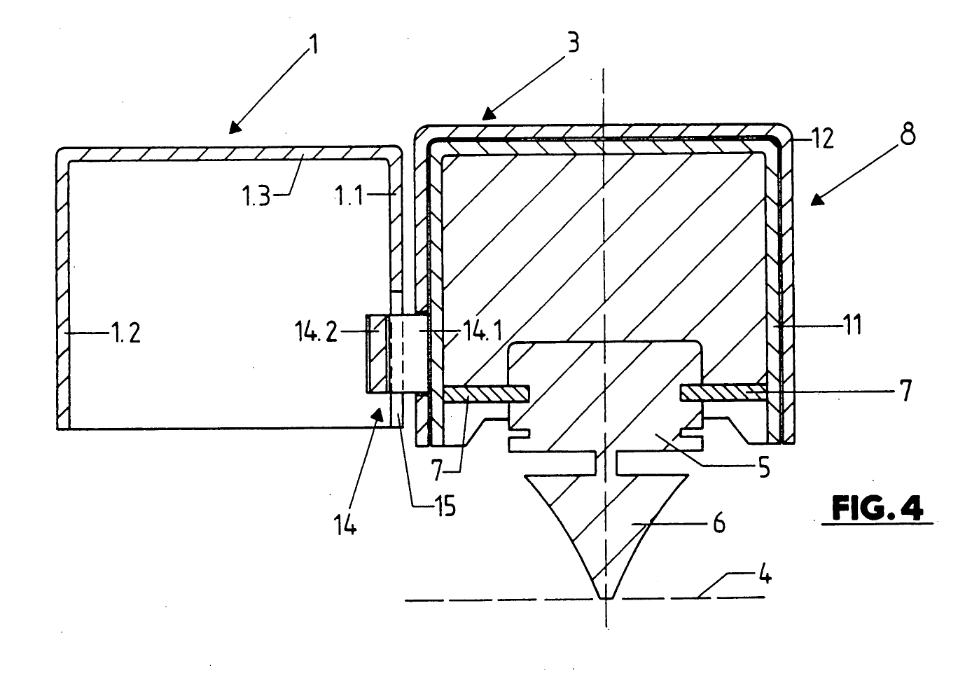

FIG. 3 u. 4 cross-sections corresponding to the lines I-I and II-II of FIG. 2.

FIG. 1 presents a wiper arm of a windscreen wiper for vehicles, for example road vehicles. The wiper arm 1 is, at its end presented in the figures, to which the exchangeable wiper blade 2 is attached with a connection or link generally denoted in the figures by 3 (side pin connection), illustrated as facing downwards, i.e. towards the open U profile facing the vehicle windscreen indicated by the line 4 and indeed with the two shanks 1.1 and 1.2 and with yoke section connecting with the shank 1.3.

The wiper blade 2, which is located laterally from the wiper arm 1 and from shank 1.1 in the top view of the wiper arm-wiper blade-arrangement, i.e. in projection to the level of the vehicle windscreen 4, is illustrated in the presented realisation as a flat wiper blade, to be more precise essentially consisting of the wiper rubber 5, which among other aspects forms the wiping lip 6 lying on the vehicle windscreen 4, and of the spring rails 7 partially inserted in the lateral grooves of the wiper rubber 5 and extending over the entire length of the wiper blade, which are held at the non-illustrated ends of the wiper blade 2 in the grooves of the wiper rubber 5. Between both ends, i.e. in the middle or approximately in the middle of the wiper blade 2, a bearing or connecting element 8 is attached, which in the realisation presented overlaps the wiper rubber 5 including the spring rails 7 at the top and guarantees a releasable attachment of the wiper blade 2 laterally over a longitudinal side of the wiper arm 1, i.e. secured by the pin or connecting stud 9 projecting over the shank 1.1, and on the wiper arm 1 and on the shanks 1.1 and 1.2.

In the realisation presented, the connecting piece 8 is illustrated as a multipiece component, i.e. it consists of an internal part or carrier element 10, which is a machined part in plastic in the realisation presented and arranged directly on the wiper rubber, positively overlaps this wiper rubber together with both spring rails 7.

On the inside part 10, an essentially U-shaped reinforcing or securing element 11 made of corrosion-resistant metal sheeting is arranged by punching and bending and to be more precise, in such a way that the latter directly overlaps the inside part 10 on the upper side facing away from the wiper rubber 5 and on both lateral surfaces extending in the longitudinal direction of the wiper blade 2 and is connected to the inside part 10. An outer cover cap 12 in suitable material, for example plastic, is applied and attached to the securing element 11, which covers both the inside part 10 and also the securing element 11 and thereby forms the outer surface of the connecting piece 8.

All the elements 10-12 respectively have openings arranged in the same axis to one another, which make up a bearing or connecting opening 13, which with the wiper blade connected to the wiper arm 1, the connecting stud 9 is accommodated insofar as possible free of play and to be more precise, in such a manner that a limited pivoting movement of the wiper blade mounted on the wiper arm and lying against the vehicle windscreen is possible around the axis of the connecting stud 9.

For axial securing of the wiper blade 2 on the connecting stud 9, the connecting piece 8 is illustrated with a locking element 14, which projects over the side adjacent to the wiper arm of the connecting piece 8 with the wiper blade 2 installed and clamps behind shank 1.1 forming the adjacent side of the wiper arm 1 on the inside surface of the shank. In the realisation presented, the shank 1.1 has a slot-shaped opening 15, which extends starting from the lower, free edge of the shank 1.1 in the direction of the yoke section 1.3 and to be more precise in the realisation present, bends around the axis of the connecting studs 9 in an arch shape.

With the wiper blade 2 attached and axially secured on the wiper arm 1, the locking element 14 reaches through the slot-shaped openings 15 with a section 14.1 running approximately parallel to the axis of the connecting stud and radially distanced from the latter and clamps behind the shank 1.1 on its inside surface in the area of the edge of the 15 with an angle 14.2 or an enlarged head piece. The design is such that in every possible position of the wiper blade 2 in relation to the wiper arm 1 during normal operation, this axial securing is reliably guaranteed by the locking element 14.

In order to install the wiper blade 2 on the wiper arm 1 or for replacement of an existing wiper blade 2 with a new wiper blade 2, the wiper arm 1, which is usually pretensioned by at least one spring in its position pressing the wiper blade 2 against the vehicle windscreen, according to the arrow A in FIG. 2 pivots away from the vehicle windscreen 4, so that for example when removing an existing wiper blade 2, the latter can be pivoted around the axis of the connecting studs 9 in such a way until the locking element 14 is disengaged with the wiper arm 1 and the shank 1.1, so that the wiper blade 2 can be pulled off the connecting stud 9. Fixing of the wiper blade 2 to the wiper arm 1 is performed analogously in reverse.

The locking element 14 is formed in the realisation presented by a hook-like angled extension of a shank of the securing elements 11. By manufacture of the securing element 11 from metal and as a result of the single-piece design of this securing element 11 with the locking element 14, full account is also taken of the high safety requirements specifically for vehicles, i.e. even if the cover cap 12 or the connection between the elements 10 and 11 is released, the wiper blade 2 continues to be held on the wiper arm 1 by the joint connecting stud 9 and by the securing element 11 overlapping in the manner of a fork and manufactured in one piece with the locking element 14.

The invention has been described above in an example of realisation. It is understood that many modifications and alterations are possible, without the thought on which the invention is based being abandoned.

It is therefore possible to dispense with the cover cap 12 and inject around the securing element 11 with a suitable plastic and establish a suitable connection with the inside part 10 and to be more precise in such a manner that convenient installation of the parts in relation to one another without any displacement is possible.

In principle, the possibility also exists of manufacturing the connecting piece 8 of the wiper blade 2 for the side pin connection in one piece and to be more precise with a reinforcement element embedded and injected and manufactured from metal forming the locking element 14 for axial securing, which at least directly overlaps the wiper blade 2 and the latter's wiper rubber 5 in the manner of a fork or a slide.

### LIST OF REFERENCE SIGNS

1 wiper arm
1.1, 1.2 shank
1.3 yoke section
2 wiper blade
3 side pin connection for the wiper blade 2 on the wiper arm 1
4 vehicle windscreen
5 wiper rubber
6 wiping lip
7 spring rail
8 connecting piece
9 pin or connecting stud on the wiper arm 1
10 inside element of the connecting piece 8
11 reinforcement and securing element of the connecting piece 8
12 cover cap of the connecting piece 8
13 connecting opening for the connecting stud 9
14 locking element
14.1, 14.2 section of the locking element
15 slot-shaped opening
A direction of pivoting on raising the wiper arm 1 from the vehicle windscreen 4

1. Connection between a wiper arm of a windscreen wiper unit and a wiper blade arranged at one end of the wiper arm and arranged at least in the area of the connection in projection onto a vehicle windscreen laterally from a wiper arm side, which is pushed with a bearing opening in a connecting piece axial onto a wiper arm side connecting stud projecting over the wiper arm side and which is secured to the connecting stud by subsequent pivoting around the axis of this connecting study by locking surfaces which clamp behind each other axially on the connecting stud, with one of the locking surfaces is formed on a locking element,
wherein the locking element is at an interval from one of the sides of the connecting piece adjacent to the wiper arm and with the wiper blade axially secured to the wiper arm clamps behind a surface of the wiper arm adjacent to the connecting piece.

2. Connection according to claim 1, wherein the wiper arm on its surface adjacent to the connecting piece has a locking opening through which, in the axially secured state of the wiper blade, the locking element with its securing section clamping behind the wiper arm extends.

3. Connection according to claim 2, wherein the locking opening is of slotted design and is oriented in its length crossways to the longitudinal axis of the wiper arm.

4. Connection according to claim 2, wherein the locking opening—is designed circular in shape or approximately circular in around the axis of the connecting stud.

5. Connection according to claim 1, wherein the wiper arm in the area of the connection is designed as a U profile and that the area adjacent to the wiper blade of this U profile.

6. Connection according to claim 1, wherein the locking element is formed of a machined part or a section of a machined part in metal sheeting, which is pushed onto the connecting stud with the wiper blade installed on the wiper arm.

7. Connection according to claim 6, wherein the machined part forms a U profile directly or indirectly overlapping the wiper blade or a wiper rubber with spring rails.

8. Connection according to claim 7, wherein each shank of the U profile of the machined part a hole is provided respectively for the connecting stud.

9. Connection according to claim 7, wherein the machined part as a securing and/or reinforcement element overlaps with its shanks a carrier or holder element for the wiper rubber and also if necessary for further functional elements of the wiper blade, for example for spring rails.

10. Connection according to claim 1, wherein the machined part is covered by a cover cap.

11. Connection according to claim 9, wherein the carrier element and/or cover cap are machined parts in plastic.

12. Connection according to claim 1, wherein the locking element and/or the machined part have rubber injected around them.

13. Connection according to claim 1, wherein the locking element is designed with a hook shape or in the form of an enlarged head piece on one of the partial sections resulting in axial securing.

14. Windscreen wiper arrangement for vehicles with at least one wiper arm and a wiper blade designed to be exchangeable at one free end of the wiper arm by means of a connection, wherein the connection is designed according to claim 1.

15. Connection according to claim 3, wherein the locking opening—is designed circular in shape or approximately circular in around the axis of the connecting stud.

16. Connection according to claim 8, wherein the machined part as a securing and/or reinforcement element overlaps with its shanks a carrier or holder element for the wiper rubber and also if necessary for further functional elements of the wiper blade, for example for spring rails.

17. Connection according to claim 1, wherein the machined part is covered by a cover cap.

18. Connection according to claim 10, wherein the carrier element and/or cover cap are machined parts in plastic.
